(19) United States
(12) Patent Application Publication
(10) Pub. No.: US 2014/0225780 A1
(43) Pub. Date: Aug. 14, 2014

(54) USING TIME-DIFFERENCE-OF-ARRIVAL TO DETECT A POSITION OF A TARGET TRANSMITTER

(71) Applicant: Huaping Liu, (US)

(72) Inventor: Huaping Liu, Corvallis, OR (US)

(73) Assignee: the State of Oregon acting by and through the State Board of Higher Education on behalf of Orego, Corvallis, OR (US)

(21) Appl. No.: 14/174,322

(22) Filed: Feb. 6, 2014

Related U.S. Application Data
(60) Provisional application No. 61/763,414, filed on Feb. 11, 2013.

(51) Int. Cl. G01S 5/04

(52) U.S. Cl. CPC G01S 5/04
USPC 342/465

(57) ABSTRACT

Multiple time-difference-of-arrival units, each having two or more receiver antennas can be used to determine a location of a target transmitter without synchronizing or connecting together the units. Specifically, a clock on each unit can be used to determine a difference of arrival of radio-frequency signals amongst antennas on the units. Each unit's clock can be asynchronous with the clocks on the other units. Target estimation can therefore be achieved easily with limited wiring and the problems associated with synchronization can be reduced or eliminated. The multiple time-difference-of-arrival units can be used in indoor, outdoor (or a combination thereof) applications.

### CROSS REFERENCE TO RELATED APPLICATION

This application claims priority from U.S. Provisional Application No. 61/763,414, filed Feb. 11, 2013, which is incorporated herein by reference in its entirety.

### ACKNOWLEDGMENT OF GOVERNMENT SUPPORT

This invention was made with government support under IIS-1118017 awarded by National Science Foundation. The government has certain rights in the invention.

### FIELD

This application relates to the use of time-difference-of-arrival (TDOA) information to localize objects.

### BACKGROUND

U-TDOA, or Uplink-Time Difference of Arrival, is a wireless location technology that relies on sensitive receivers typically located at the cell towers to determine the location of a mobile phone. U-TDOA determines location based on the time difference it takes a signal to travel from a mobile phone to different sensitive receivers called Location Measurement Units (LMUs). By using the timing difference information from multiple LMUs, U-TDOA calculates the mobile phone's location. Because U-TDOA is a network-based location technology, it does not require the mobile phone to have any special chip, hardware, or software in it. As a result, it can locate any type of mobile phone.

Extensive work has addressed localization using TDOA, including algorithms, receiver geometry, accuracy versus required bandwidth, etc. TDOA requires clock synchronization among the receivers with known coordinates. If the receivers can be connected by cables so that all receivers share a common clock, TDOA can be applied to provide robust localization. Unfortunately, connecting the receivers using cables is costly, especially for structures that are already constructed, such as when the TDOA is used within enclosed structures (e.g., malls, buildings, etc.). Receiver clock synchronization wirelessly is theoretically feasible for indoor localization, but the resulting system will be complex, costly, and unreliable.

### SUMMARY

Considering the technical challenges of common TDOA indoor radio localization systems, especially the clock synchronization challenges, the present embodiments eliminate the need of clock synchronization among the receiver, either via cables or wirelessly, for TDOA localization and create a new architecture that is easy to deploy in indoor scenarios.

The embodiments described herein can be extended to outdoor applications. For example, the units described herein can be incorporated into cellular towers that operate independently. The embodiments can also be used in a combination of indoor/outdoor applications.

The foregoing and other objects, features, and advantages of the invention will become more apparent from the following detailed description, which proceeds with reference to the accompanying figures.

### BRIEF DESCRIPTION OF THE DRAWINGS

FIG. 1 is a system diagram showing multiple time-difference-of-arrival (TDOA) units, each having multiple receivers thereon.

FIG. 2 shows examples of placement options for the TDOA units in an enclosed space.

FIG. 3 shows alternative placement options for the TDOA units.

FIG. 4 is a flowchart according to one embodiment for calculating a position for a target transmitter.

FIG. 5 is a flowchart according to another embodiment for calculating a position for a target transmitter.

FIG. 6 is a flowchart according to yet another embodiment for calculating a position for a target transmitter.

FIG. 7 is an example architecture that can be used in the embodiments herein.

### DETAILED DESCRIPTION

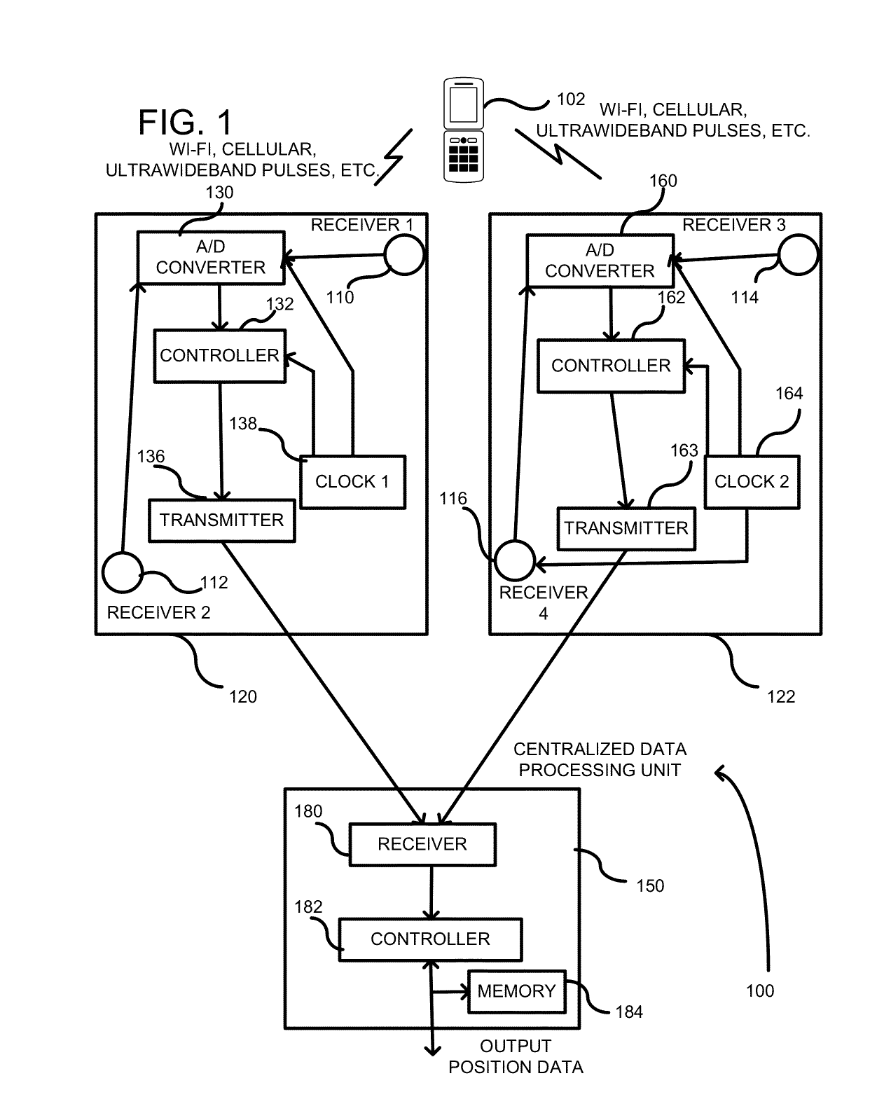

FIG. 1 shows a system 100 for calculating a position of a target transmitter 102. The target transmitter 102 can be any of a variety of computing devices (e.g., cell phone, smartphone, handheld computer, Personal Digital Assistant (PDA), etc.) or just a simple radio transmitter. Typically, the target transmitter is located indoors. However, the embodiments described herein can be extended to outdoor applications or a combination of indoor/outdoor applications. The target transmitter 102 can transmit radio signals, such as WiFi signals, cellular signals, ultrawideband pulses, etc., which can be used to estimate a current position of the target transmitter 102. In particular, the transmitted radio signals are received by a plurality of spaced-apart receiver antennas, such as those shown at 110, 112, 114 and 116, and the timing of when the signals are received can be used to estimate a position of the target transmitter 102, as further described below. The receiver antennas 110, 112, 114 and 116 are shown positioned on two or more TDOA units 120, 122, which are typically located in an enclosed area (having walls and a ceiling). In outdoor applications, the TDOA units 120, 122 can be incorporated into one or more cellular towers. As described further below, there can be any number of units and each unit can have two or more receiver antennas. A typical design has four receiver antennas on the unit, but any number can be used. Each unit typically collects independent time-difference-of-arrival (TDOA) measurements, wherein N antennas provide (N-1) TDOA measurements. As shown, unit 120 includes receiver antennas 110, 112, which receive the radio signals from the target transmitter 102 and which pass the received signals to one or more Analog-to-Digital converters (ADC) 130. The ADC 130 converts the radio signals to digital and passes the digital signals to a controller 132. The controller 132 can include one or more integrated circuits and can perform distance/time calculations on the TDOA measurements (the result of such calculations will be called hereafter TDOA information or TDOA data) or pass through the TDOA measurements unchanged. In some embodiments, the controller can include a microcontroller or a microprocessor and an associated programmable chip, such as an FPGA. However, a variety of designs can be used to implement the controller. The controller 132 can use a transmitter 136 to pass either the TDOA measurements or the TDOA information to a centralized data processing unit 150. The transmitter 136 can be a wireless transmitter or a wired network transmitter, such as an Ethernet card, and can be embedded within the controller 132 or separated therefrom. The unit 120 includes a clock 138 coupled to the controller 132 and to the ADC 130. The clock 138 can be any desired frequency depending on the design, but 10 GHz is an example frequency. The received signals from the ADC can be up sampled to a certain time resolution. The unit 120 can have the components described above populated on a printed circuit board (not shown).

If the unit 120 calculates TDOA information, it can use one receiver (e.g., receiver 110) on the unit as a reference and determine a time when a first peak (or leading edge or other characteristics of the signal that carries timing information, as is understood in the art, but for simplicity, the first peak is often used herein as an example) is detected. It can then determine when the other receivers (e.g., receiver 112) on the same unit received the same first peak. The TDOA information can then be calculated by subtracting the time between when the first receiver received the first peak and the second receiver received the first peak. If there are other receivers in the unit 120, they can likewise be used to detect the first peak and the TDOA information can be calculated by subtracting the time that the first peak was received by the reference receiver from the time when the first peak was received by the other receivers. This time difference can be used to compute a distance measurement as a first part of determining a position of target transmitter.

The unit 122 has a similar design including an ADC 160 for receiving analog radio signals from the antennas 114, 116, a controller 162, a transmitter 163 coupled to the centralized data processing unit 150, and a clock 164. Each of these components can be mounted on a printed circuit board similar to unit 120. The clock 164 is not synchronized with the clock 138. By being asynchronous, the two units do not need to be coupled together or communicate in an attempt to synchronize, which has been difficult in the past and has led to errors or additional costs. The second unit can either pass the TDOA measurements through to the centralized data processing unit 150 or can calculate the TDOA information prior to the transmission to the centralized data processing unit.

The centralized data processing unit 150 can include a receiver 180, which can be a wireless receiver or a network receiver, such as an Ethernet port. The receiver 180 can receive either TDOA measurements or the TDOA information that is calculated based on the TDOA measurements. In any event, the receiver 180 can pass either the TDOA measurements or TDOA information to a controller 182. The controller 182 can then use either the raw TDOA measurements or the TDOA information received from different units 120, 122 to compute a position of the target transmitter 102. In particular, the controller 182 uses the TDOA measurements or TDOA information in a localization algorithm, as is well understood in the art. The localization algorithm can be any desired algorithm, such as a nonlinear least squares algorithm, or a method of moments algorithm, or a SMACOF algorithm (scaling by majorizing a convex function). Iterative algorithms, such as the nonlinear least squares algorithm can be iterated a predetermined number of times (e.g., 5, 6, 7, etc . . . ) or until a threshold number is reached. Other data can also be input into the localization algorithm, such as positional coordinates of the TDOA units, and, in particular, receivers in each unit 120, 122, which can be pre-stored in a memory 184. The resultant estimated position of the target transmitter can be stored in memory 184 or output to a user, as is well understood in the art. By accepting either the TDOA raw data or the TDOA information, the controller 182 either computes everything or allows some of the processing to occur locally on the units.

Thus, the embodiment of FIG. 1 can be used in both indoor and outdoor applications or a combination thereof. In outdoor applications, cellular signals can be used for cellular phone localization wherein the multiple receivers on each cellular tower acts as a TDOA unit.

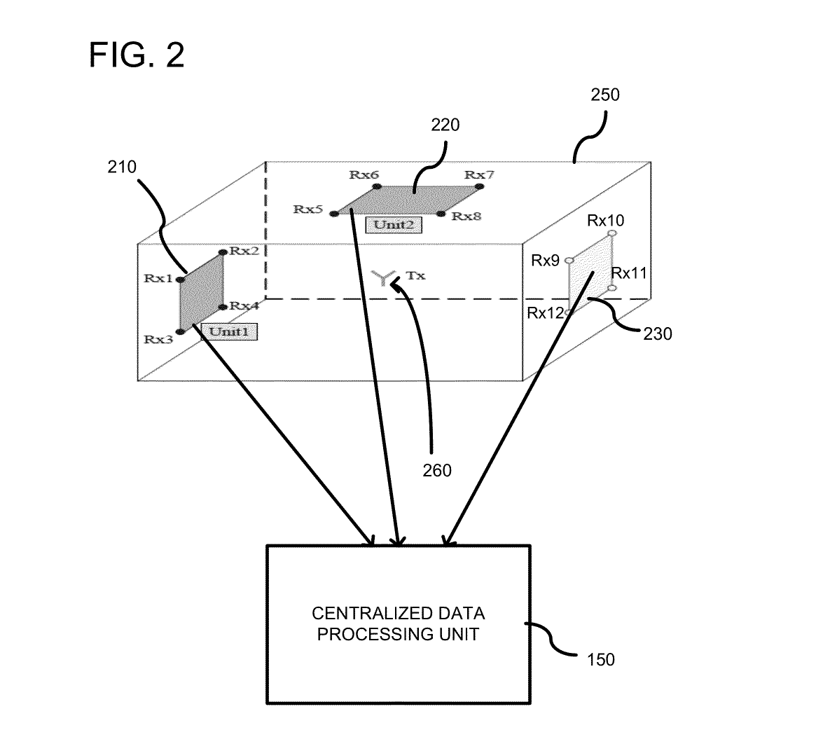

FIG. 2 is an example of an embodiment wherein three receiver units 210, 220, 230 are coupled either wireles sly or hardwired to the centralized data processing unit 150. As shown, each receiver unit has four antennas, designated as RxY, where Y is any number 1-12. Although three units are shown, additional units can be added. Additionally, although four receivers are shown per unit, any number of receivers per unit can be used (e.g., 2, 3, 4, 5, etc.) The units 210, 220, 230 take independent TDOA measurements within each unit. With Y antennas in a unit, the unit will provide (Y-1) TDOA measurements or (Y-1) TDOA information (wherein each unit calculates some distance variables locally). The size of each unit could be small, e.g., (0.5×0.5)m² or (1×1) m² on a 2-dimensional plane, or (a×b×c) m³ in a 3-dimensional plane. When used outdoors, for cell phone localization using cellular signals, for example, the size of the unit could be determined by the physical size of the cellular towers, typically in the range of meters in each dimension to tens of meters in each dimension. Note that the necessary size of the units depends on how many units are used to form a network, the localization accuracy of the system and other factors. The units are shown as having a planar shape, but can have any 3-dimensional shape, such as a cube. The units can receive any radio-frequency signals, such as WiFi or cellular signals.

A few example placements of the receiver units 210, 220, and 230 are shown in FIG. 2. As shown, a room 250 has units 210, 220, 230 placed on the walls and ceiling with a spaced relation there between. These units send their independent TDOA measurements or TDOA information of a target(s) 260 to the central location 150 via any wired or wireless link, (e.g., via WiFi). The centralized data processing unit 150 can be located on a host computer for processing continuous location information of the target(s) 260.

The architecture has many advantages: 1) Easy deployment: the transmitters whose positions are tracked could be any radio-frequency transmitters such as those designed for wireless communications (for example, a WiFi transmitter or a cellular transmitter); 2) There need not be modifications of existing hardware or addition of new hardware to such devices; 3) Easy installation: each unit can be mounted on a wall or the ceiling of a building without requiring synchronization among the distributed receiver units nor long cables to connect the distributed receive antennas; 4) Robust operation: since no wireless synchronization is required, the operation of this system will be more robust than conventional systems; 5) Flexible to accommodate different location accuracy requirements: there are multiple degrees of freedom that can be exploited to accommodate different location accuracy requirements. For example, the number of receive antennas in each unit, the number of units per area to be covered, and the size of the receiver units can all be optimized flexibly for any scenario.

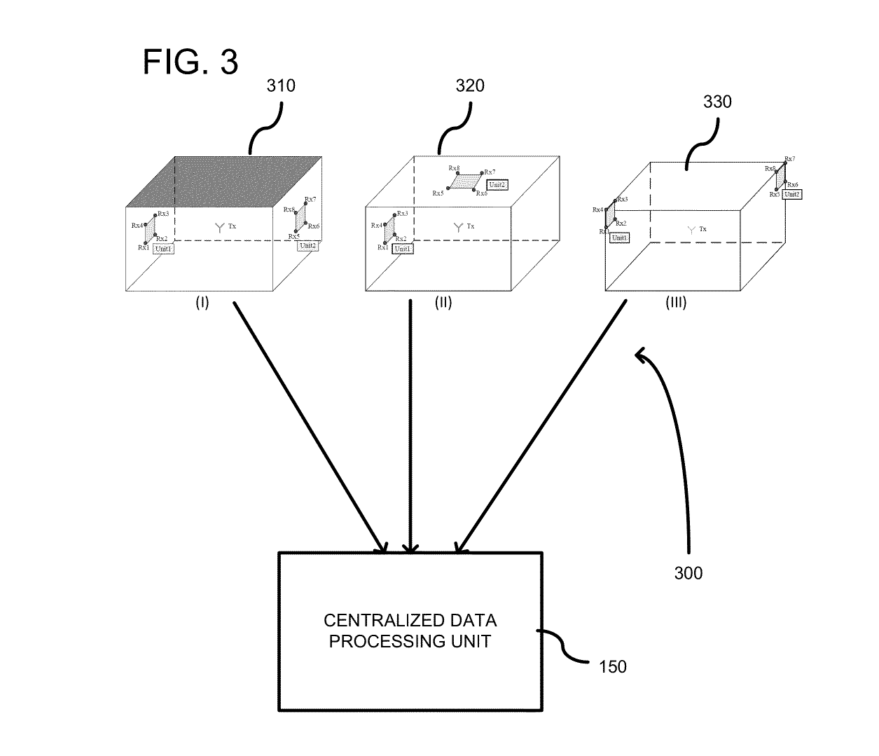

FIG. 3 shows another embodiment wherein the centralized data processing unit 150 is tracking multiple target transmitters simultaneously, such as those shown in rooms 310, 320 and 330. The rooms 310, 320 and 330 are shown with different potential configurations for the units. Room 310 is shown with two units on opposite walls, with each unit having four receivers. The room 320 has two units with one centrally located on a wall and the other on a ceiling. Room 330 shows two units at opposite corners of the room. A variety of configurations can be used including adding additional units to each room or adding or removing antennas from each unit.

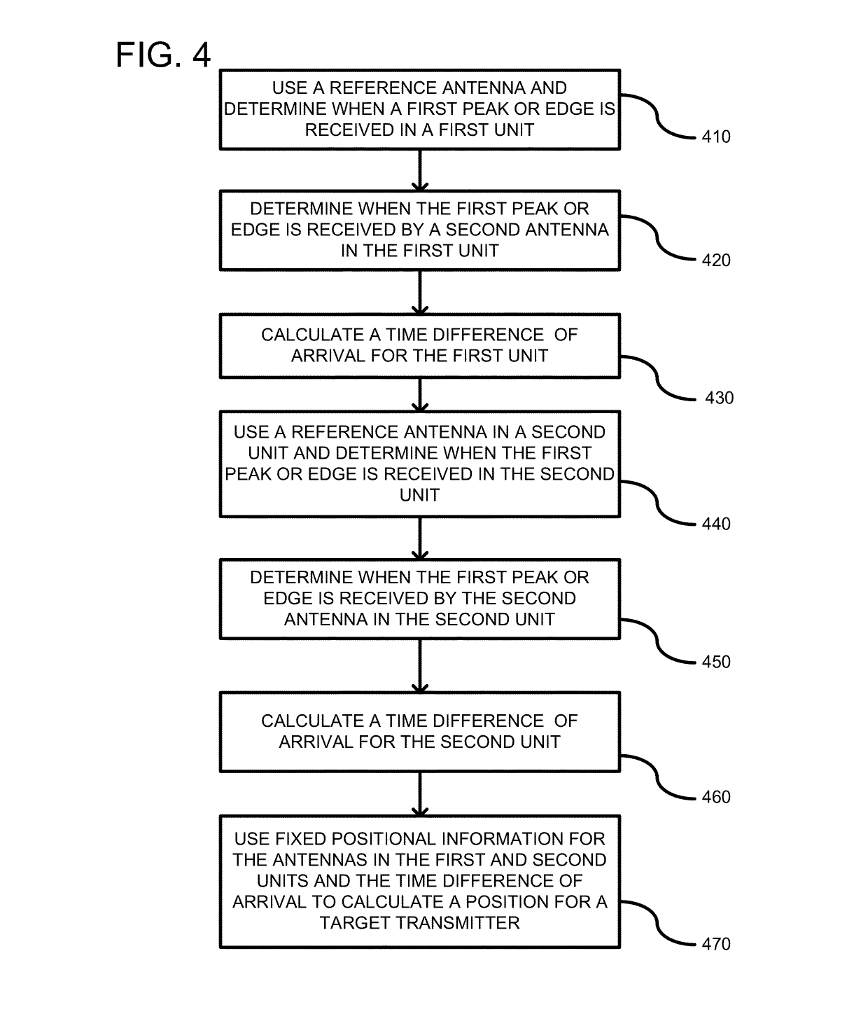

FIG. 4 is a flowchart of a method for detecting a position of a target transmitter. In process block 410, a reference antenna can be used to determine when a first peak or leading edge is received in a first unit. Other detection techniques can be used other than first peak or edge, depending on the particular design. Generally, the first peak or leading edge has to surpass a threshold level so as to be distinguished from any noise. Each unit being used can have its own reference antenna or receiver which detects the peak or edge of a pulse transmitted by a target transmitter. In process block 420, a determination is made when the first peak or edge that was received by the reference antenna is now received in a second antenna within the same unit. In process block 430, a calculation can be made on a time difference of arrival between the second antenna's detection of the peak or edge and the reference antenna's detection. The calculation can be a positive or negative number depending on the timing of when the edge was received by the second antenna relative to the first antenna. In process block 440, a reference antenna in a second unit is also used to detect when the first peak or edge is received by the second unit. The second unit is likely positioned at a different distance from the target transmitter so the first peak or edge is received by the reference antenna in the second unit at a different time than the first unit. Nonetheless, the first unit and second unit are not synchronized with respect to each other and they operate independently. In process block 450, a determination is made when the first peak or edge is received by the second antenna in the second unit. In process block 460, a time difference can be calculated between the arrival of the peak in the second antenna of the second unit and the reference antenna of the second unit. In process block 470, fixed position information for the antennas in the first and second units together with the time difference of arrival information for both units can be used to calculate a position of the target transmitter. As discussed above, there are a variety of algorithms that can be used to perform such a calculation. Process blocks 430 and 460 can be calculated either locally in the TDOA units or in the centralized data processing unit. Process block 470 is calculated by the centralized data processing unit. However, if desired, the centralized data processing unit can be positioned on one of the units. As described above, the process blocks described herein can be used in both indoor and outdoor applications, as well as applications that combine indoor and outdoor.

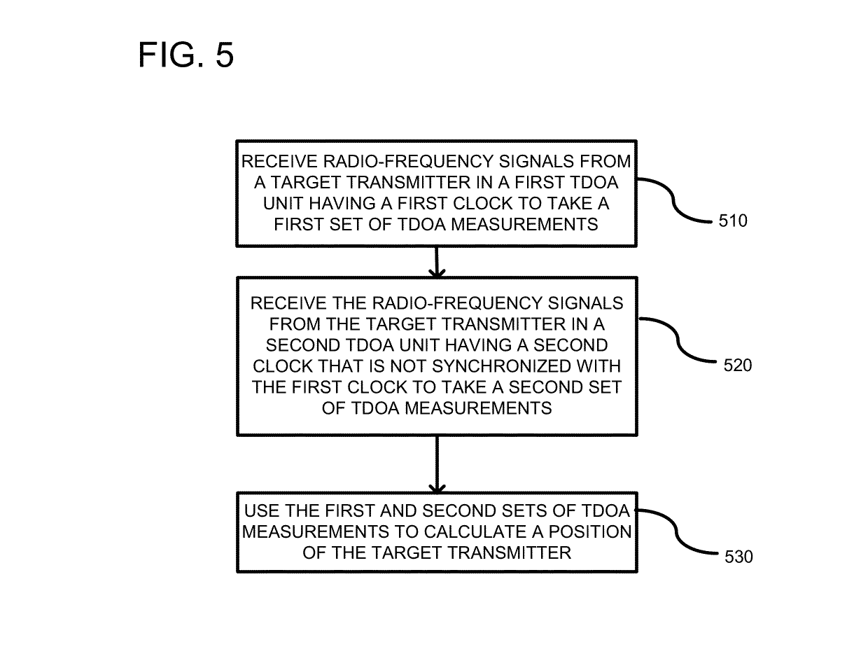

FIG. 5 is a flowchart of a method according to one embodiment for detecting a position of a target transmitter. In process block 510, radio-frequency signals from a target transmitter are received in a first TDOA unit having a first clock. The radio-frequency signals can be any type of radio-frequency signal, such as WiFi, cellular, ultrawideband, etc. The first TDOA unit can use the first clock to take a first set of TDOA measurements by detecting when a peak or edge of the radio-frequency signal is received in different antennas in relationship to the local clock signal on the TDOA unit. Such TDOA measurements occur between at least two different antennas in the TDOA unit. In process block 520, at least a second TDOA unit can receive the same radio-frequency signals from the target transmitter. The same radio-frequency signal that was received in the first TDOA unit can be received by two or more antennas in the second TDOA unit. The second TDOA unit can have a second clock that is not synchronized with clocks in the other TDOA units. The second clock can be used to generate a second set of TDOA measurements associated with the second unit. In process block 530, the first and second sets of TDOA measurements can be used to calculate a position of the target transmitter. A portion of the calculation can be accomplished in the TDOA units themselves and a portion can be calculated in a centralized data processing unit or, alternatively, all of the calculations can be calculated in the centralized data processing unit. In some embodiments, it is possible to have the centralized data processing unit on one of the TDOA units. In any case, the coordinates of the antennas in the first and second TDOA units are used together with the timing information from the first and second sets of TDOA measurements to calculate a position of the target transmitter. As previously described, additional TDOA units can be added, such as third and fourth TDOA units, and each TDOA unit has its own clock that is asynchronous with the other clocks. The centralized data processing unit can use sets of TDOA measurements from each of the units in estimating the target transmitter's position. Such estimating can be accomplished using a non-linear least squares analysis or other algorithms for computing position given the time of receipt information.

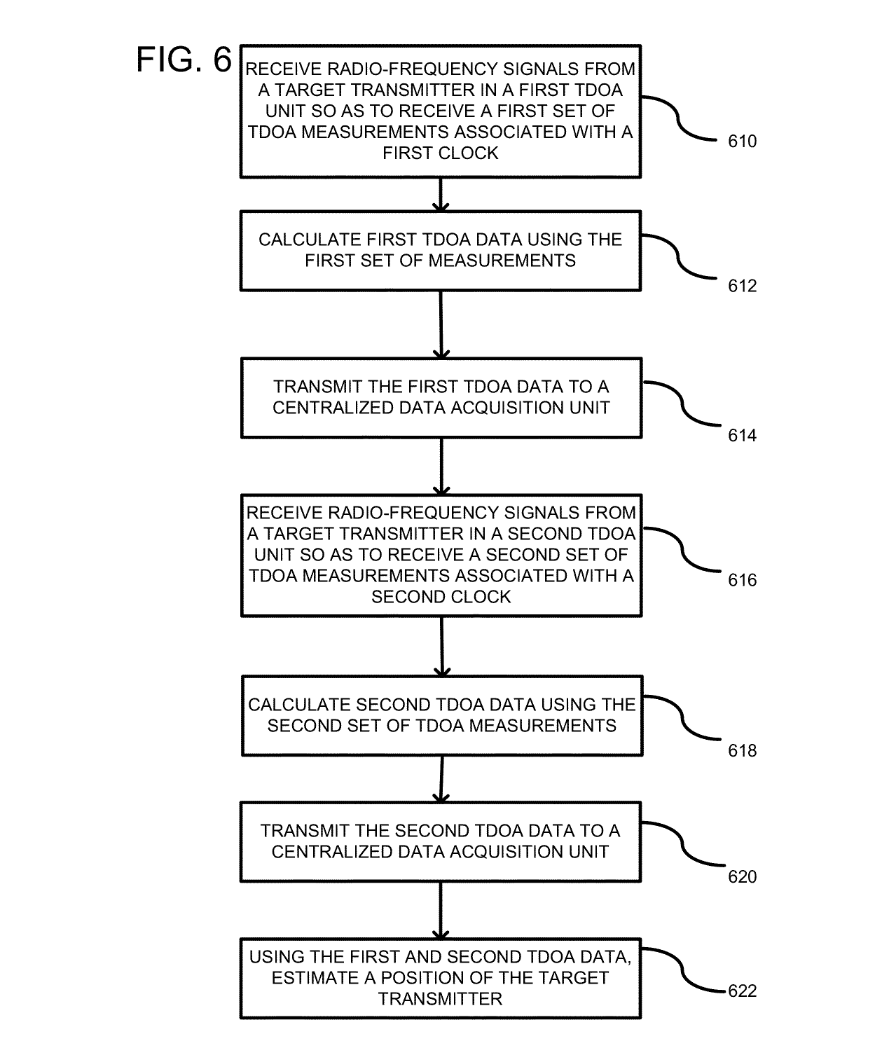

FIG. 6 shows another flowchart of an embodiment wherein TDOA data is first calculated on the TDOA units and then transmitted to the centralized data processing unit. In process block 610, radio-frequency signals are received from a target transmitter in a first TDOA unit so as to receive a first set of TDOA measurements associated with a first clock. The first set of TDOA measurements can include signal data from multiple antennas, one of which is designated as a reference antenna. In process block 612, first TDOA data is calculated using the first set of TDOA measurements. Such a calculation can be accomplished using the clock and the timing differences when the same peak or leading edge of the target's transmitted signal arrives at different receivers on the same unit. In process block 614, the first TDOA data can be transmitted to the centralized data processing unit. The transmission can occur wirelessly or via a wired connection. In process block 616, radio-frequency signals are received from the target transmitter in a second TDOA unit so as to receive a second set of TDOA measurements associated with a second clock, which is not synchronized with the clocks of any of the other TDOA units. The second set of TDOA measurements can include receiving the pulse transmission in a reference antenna and at least a second antenna. In process block 618, second TDOA data can be calculated using the second set of TDOA measurements. The second TDOA data can be calculated using the clock timing associated with when the pulses are received in each antenna. In process block 620, the second TDOA data can be transmitted to the centralized data processing unit. In process block 622, using the first and second TDOA data and the known positions of the antennas in each of the TDOA units, the centralized data processing unit can estimate a position of the target transmitter.

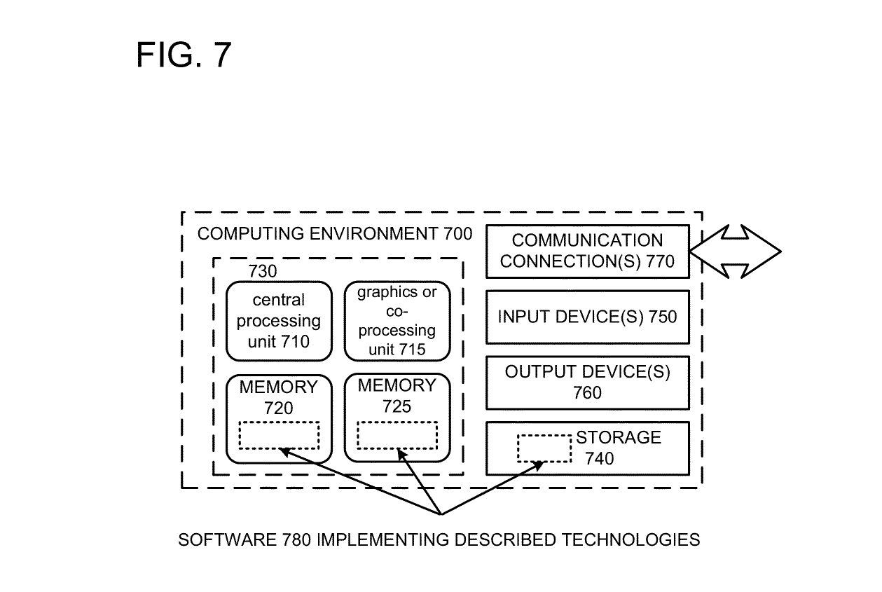

FIG. 7 depicts a generalized example of a suitable computing environment 700 in which the described innovations may be implemented. In particular, the computing environment can be on a TDOA unit or it can be used as the centralized data acquisition/processing unit. The computing environment 700 is not intended to suggest any limitation as to scope of use or functionality, as the innovations may be implemented in diverse general-purpose or special-purpose computing systems. For example, the computing environment 700 can be any of a variety of computing devices (e.g., desktop computer, laptop computer, server computer, tablet computer, media player, gaming system, mobile device, etc.)

With reference to FIG. 7, the computing environment 700 includes one or more processing units 710, 715 and memory 720, 725. In FIG. 7, this basic configuration 730 is included within a dashed line. The processing units 710, 715 execute computer-executable instructions. A processing unit can be a general-purpose central processing unit (CPU), processor in an application-specific integrated circuit (ASIC) or any other type of processor. In a multi-processing system, multiple processing units execute computer-executable instructions to increase processing power. For example, FIG. 7 shows a central processing unit 710 as well as a graphics processing unit or co-processing unit 715. The tangible memory 720, 725 may be volatile memory (e.g., registers, cache, RAM), non-volatile memory (e.g., ROM, EEPROM, flash memory, etc.), or some combination of the two, accessible by the processing unit(s). The memory 720, 725 stores software 780 implementing one or more innovations described herein, in the form of computer-executable instructions suitable for execution by the processing unit(s).

A computing system may have additional features. For example, the computing environment 700 includes storage 740, one or more input devices 750, one or more output devices 760, and one or more communication connections 770. An interconnection mechanism (not shown) such as a bus, controller, or network interconnects the components of the computing environment 700. Typically, operating system software (not shown) provides an operating environment for other software executing in the computing environment 700, and coordinates activities of the components of the computing environment 700.

The tangible storage 740 may be removable or non-removable, and includes magnetic disks, magnetic tapes or cassettes, CD-ROMs, DVDs, or any other medium which can be used to store information in a non-transitory way and which can be accessed within the computing environment 700. The storage 740 stores instructions for the software 780 implementing one or more innovations described herein.

The input device(s) 750 may be a touch input device such as a keyboard, mouse, pen, or trackball, a voice input device, a scanning device, or another device that provides input to the computing environment 700. For video encoding, the input device(s) 750 may be a camera, video card, TV tuner card, or similar device that accepts video input in analog or digital form, or a CD-ROM or CD-RW that reads video samples into the computing environment 700. The output device(s) 760 may be a display, printer, speaker, CD-writer, or another device that provides output from the computing environment 700.

The communication connection(s) 770 enable communication over a communication medium to another computing entity. The communication medium conveys information such as computer-executable instructions, audio or video input or output, or other data in a modulated data signal. A modulated data signal is a signal that has one or more of its characteristics set or changed in such a manner as to encode information in the signal. By way of example, and not limitation, communication media can use an electrical, optical, RF, or other carrier.

Although the operations of some of the disclosed methods are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed methods can be used in conjunction with other methods.

Any of the disclosed methods can be implemented as computer-executable instructions stored on one or more computer-readable storage media (e.g., non-transitory computer-readable media, such as one or more optical media discs, volatile memory components (such as DRAM or SRAM), or nonvolatile memory components (such as flash memory or hard drives)) and executed on a computer (e.g., any commercially available computer, including smart phones or other mobile devices that include computing hardware). As should be readily understood, the term computer-readable storage media does not include communication connections, such as modulated data signals. Any of the computer-executable instructions for implementing the disclosed techniques as well as any data created and used during implementation of the disclosed embodiments can be stored on one or more computer-readable media (e.g., non-transitory computer-readable media, which excludes propagated signals). The computer-executable instructions can be part of, for example, a dedicated software application or a software application that is accessed or downloaded via a web browser or other software application (such as a remote computing application). Such software can be executed, for example, on a single local computer (e.g., any suitable commercially available computer) or in a network environment (e.g., via the Internet, a wide-area network, a local-area network, a client-server network (such as a cloud computing network), or other such network) using one or more network computers.

For clarity, only certain selected aspects of the software-based implementations are described. Other details that are well known in the art are omitted. For example, it should be understood that the disclosed technology is not limited to any specific computer language or program. For instance, the disclosed technology can be implemented by software written in C++, Java, Perl, JavaScript, Adobe Flash, or any other suitable programming language. Likewise, the disclosed technology is not limited to any particular computer or type of hardware. Certain details of suitable computers and hardware are well known and need not be set forth in detail in this disclosure.

It should also be well understood that any functionality described herein can be performed, at least in part, by one or more hardware logic components, instead of software. For example, and without limitation, illustrative types of hardware logic components that can be used include Field-programmable Gate Arrays (FPGAs), Application Specific Integrated Circuits (ASICs), Program-specific Standard Products (ASSPs), System-on-a-chip systems (SOCs), Complex Programmable Logic Devices (CPLDs), etc.

Furthermore, any of the software-based embodiments (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, software applications, cable (including fiber optic cable), magnetic communications, electromagnetic communications (including RF, microwave, and infrared communications), electronic communications, or other such communication means.

The disclosed methods, apparatus, and systems should not be construed as limiting in any way. Instead, the present disclosure is directed toward all novel and nonobvious features and aspects of the various disclosed embodiments, alone and in various combinations and subcombinations with one another. The disclosed methods, apparatus, and systems are not limited to any specific aspect or feature or combination thereof, nor do the disclosed embodiments require that any one or more specific advantages be present or problems be solved.

In view of the many possible embodiments to which the principles of the disclosed invention may be applied, it should be recognized that the illustrated embodiments are only preferred examples of the invention and should not be taken as limiting the scope of the invention. Rather, the scope of the invention is defined by the following claims. We therefore claim as our invention all that comes within the scope of these claims.

We claim:

1. A system for detecting position of a target transmitter, comprising:
two or more time-difference-of-arrival (TDOA) units, each TDOA unit including two or more receivers that are synchronized together within the TDOA unit to obtain one or more TDOA measurements, but wherein each TDOA unit operates asynchronously with respect to the other TDOA units; and
a centralized data processing unit that receives the TDOA measurements or TDOA information calculated based on the TDOA measurements from the two or more TDOA units in order to estimate a position of the target transmitter.

2. The system of claim 1, wherein positional coordinates of each TDOA unit are stored on the centralized data processing unit and the centralized data processing unit calculates the position of the target transmitter using either the TDOA measurements or the TDOA information in conjunction with the positional coordinates of each TDOA.

3. The system of claim 1, wherein each TDOA unit includes the two or more receivers synchronized together through a common clock.

4. The system of claim 1, wherein each TDOA unit receives at least two TDOA measurements and calculates a localized difference in time of arrival to generate the TDOA information.

5. The system of claim 1, wherein each TDOA unit is connected to the centralized data processing unit through a network connection, and the TDOA units are positioned indoors or outdoors.

6. The system of claim 1, wherein each TDOA unit is connected to the centralized data processing unit through a wireless communication.

7. The system of claim 1, wherein the two or more TDOA units include a first TDOA unit having a first clock and a second TDOA unit having a second clock, wherein the first and second clocks are not synchronized.

8. A method for detecting position of a target transmitter, comprising:
receiving radio-frequency signals from the target transmitter in a first set of receivers in a first time-difference-of-arrival (TDOA) unit so as to receive a first set of TDOA measurements associated with a first clock;
receiving the radio-frequency signals from the target transmitter in a second set of receivers in a second time-difference-of-arrival (TDOA) unit so as to receive a second set of TDOA measurements associated with a second clock that is not synchronized with the first clock; and
using at least the first and second sets of TDOA measurements, calculating a position of the target transmitter.

9. The method of claim 8, further including transmitting the first and second set of TDOA measurements to a centralized data processing unit;

10. The method of claim 8, wherein coordinates of each TDOA unit are known by the centralized data processing unit and used in the estimating of the position of the target transmitter.

11. The method of claim 8, further including providing third and fourth TDOA units that are asynchronous to the first and second TDOA units; and the method further includes receiving TDOA measurements from the third and fourth TDOA units and using the measurements from the third and fourth TDOA units in calculating the position of the target transmitter.

12. The method of claim 8, wherein the receivers are antennas and wherein the received radio-frequency signals are passed from the antennas to an analog-to-digital converter prior to being passed to the centralized data processing unit.

13. The method of claim 8, wherein the transmitting to the centralized data processing unit occurs either wirelessly or via a network cable.

14. The method of claim 8, wherein estimating the position of the target transmitter includes using non-linear least squares analysis.

15. The method of claim 8, wherein the first TDOA unit includes a first printed circuit board with the first clock mounted thereon and the second TDOA unit includes a second printed circuit board with the second clock mounted thereon.

16. A computer-readable storage for detecting position of a target transmitter, comprising:
receiving radio-frequency signals from the target transmitter in multiple receivers in a first time-difference-of-arrival (TDOA) unit so as to receive a first set of TDOA measurements associated with a first clock;
calculating first TDOA data using the first set of TDOA measurements;
transmitting the first TDOA data to a centralized data processing unit;
receiving the radio-frequency signals from the target transmitter in multiple receivers in a second TDOA unit so as to receive a second set of TDOA measurements associated with a second clock that is not synchronized with the first clock;
calculating second TDOA data using the second set of TDOA measurements;
transmitting the second TDOA data to a centralized data processing unit; and
using the first and second TDOA data, estimating a position of the target transmitter.

17. The computer-readable storage of claim 16, wherein coordinates of each TDOA unit are known by the centralized data processing unit and used in the estimating of the position of the target transmitter.

18. A system for detecting position of a target transmitter, comprising:
multiple time-difference-of-arrival (TDOA) units placed in an indoor or outdoor space, wherein the TDOA units are not synchronized with each other;
wherein each TDOA unit includes multiple receivers, synchronized together internally within the unit to generate TDOA measurements; and
a central processor for receiving the TDOA measurements from the multiple units in order to calculate a position of the target transmitter.

19. The system of claim 18, wherein each TDOA unit has at least two receivers placed at different locations therein.

20. The system of claim 18, wherein the central processor receives positional coordinates of each TDOA unit.
